(19) United States
(12) Patent Application Publication
(10) Pub. No.: US 2012/0069969 A1
(43) Pub. Date: Mar. 22, 2012

(54) TELECOMMUNICATION QUALITY MEASUREMENT SYSTEM ADAPTED FOR SHARING TEST EQUIPMENT BETWEEN OPERATORS

(76) Inventor: Peter Lager, Limassol (CY)

(21) Appl. No.: 13/375,491

(22) PCT Filed: Jun. 9, 2010
(86) PCT No.: PCT/SE2010/000161

§ 371 Date: Dec. 1, 2011

(30) Foreign Application Priority Data
Jun. 12, 2009 (SE) 0900802-0

(51) Int. Cl. H04M 1/24

(52) U.S. Cl. 379/1.03

(57) ABSTRACT

A telecommunications quality measurement system has dialers that initiate and receive telephonic test-calls through voice-oriented networks under the control and supervision of test-call-system servers. A test-call-system common server comprises a locking and queuing device that queues lock queries from test-call-system servers. Locks prevent concurrent test-calls to parties of terminating dialers. The test-call-system servers are granted permission to command initiation of test calls, one at the time in a first-come-first-serve manner to a specific party. The test-call-system common server and the terminating dialers are connected to a data-oriented network for facilitating data communication between them. Results from the test calls are sent from the terminating dialers to the appropriate test-call-system servers via the test-call-system common server.

### TECHNICAL AREA

The present invention relates to telecommunications. More specifically, the invention relates to a system for telecommunications quality measurements.

### BACKGROUND ART

For facilitating telecommunications in the world, there is employed a global telecommunications interconnection network. It comprises traditional fixed Public Switched Telephony Networks (PSTN) to which e.g. Plain Old Telephone Service (POTS) terminals are connected. It furthermore comprises a diversity of networks that employ other technologies, to cater for other telecommunication services and other types of terminals.

A traditional PSTN is based on circuit switching. It is a technology well adapted for POTS because of its real-time characteristics. At the advent of data communication, modems were introduced for sending data through PSTNs. However, packet switched networks emerged because of their superior efficiency for data communication. The Internet is an example of a network that uses packet switching technology.

Voice telephony, video telephony and other streaming services with similar real-time characteristics are called voice-type services. A network that carries out voice-type services is referred to as voice oriented. Voice-oriented networks are designed to comply with real-time requirements specific to voice-type services. A traditional PSTN that conveys POTS voice calls is an example of a voice-oriented network. Another example of a voice-oriented network is a Transport Control Protocol/Internet Protocol (TCP/IP) or Universal Datagram Protocol (UDP/IP) network used for Internet based telephony. Such a network uses e.g. Voice-Over-Internet-Protocol (VoIP) and Real-Time-Protocol (RTP). Voice-type services are thus provided through different technologies.

A network that carries out data communication is referred to as data oriented. Data-oriented networks are designed to comply with data integrity requirements, i.e. to convey data without bit-errors. In the event of bit-errors, data is re-transmitted. A TCP/IP network that conveys data relating to text messages is an example of a data-oriented network. TCP/IP is a widely adopted protocol for data communication services, and is becoming more and more common for voice-type services as voice-services migrate from PSTNs to the Internet.

Through some of the technologies used in the global telecommunications interconnection network, multiple services are integrated into one and the same terminal. Universal Mobile Telephony System (UMTS) is an example of this, which provides cellular voice and video telephony as well as broadband access to the Internet, through a mobile handset or a Wireless Wide Area Network (WWAN) modem in a computer. Such a terminal is connected to both voice-oriented and data-oriented networks via an air-interface.

Examples of other terminals that can be connected to the global telecommunications interconnection network are Local Area Network (LAN) routers, Wireless Local Area Network (WLAN) routers and Digital Subscriber Loop (DSL) modems.

The global telecommunications interconnection network can be regarded as divided into distinct but interconnected networks that are specific to e.g. a region, a technology or a particular telecommunication service.

For example, a telephone call from one party to another may traverse a PSTN in a first region, a long distance carrier network through a second region, and a Public Landline Mobile Network (PLMN) in a third region.

These distinct networks are often operated and owned by different public or private enterprises. Depending on services provided and other factors, these enterprises are known as e.g. network operators, telcos, Public Telephone and Telegraph administrations (PTTs), Internet Service Providers (ISPs) and carriers. In the forthcoming, they are all simply referred to as operators.

Occasionally, these networks do not perform to acceptable standards. For example, voice or video quality in a voice-oriented network may be inferior, or a network signals false answer. False answer is when a network of a called party replies to a network of a calling party that the called party has seized the call although it has not, resulting in incorrect call-charging.

One service that an operator may provide in a voice-oriented network is sometimes called “Calling Line Identification Presentation” (CLIP). In brief, it means that a telephone number or other identifier of a calling party is sent to a called party at the time of a call setup. The identity of the calling party is for example presented as a telephone number on a display on the called party's handset. A telephone number is a number of an E-163, E-164 or ENUM number plan, or equivalent.

The means to facilitate this service vary depending on the type of terminal, the telecommunication service and the network. Signaling protocols involved can be Signaling System number Seven (SS7) and Session Initiation Protocol (SIP), but there exist others as well. The former is used e.g. for traditional PSTNs while the latter is used e.g. for Internet based telephony. SS7 and SIP are standardized common-channel signaling protocols. Common-channel signaling uses data-oriented networks for control signaling relating to voice-oriented networks. They are used for enabling set-up and tear-down of telephony voice connections, among other things.

An interface between a POTS terminal and a PSTN is called a subscriber loop. There are different protocols for supporting CLIP in the subscriber loop, including e.g. Telcordia GR-30 FSK, NTT FSK, ETSI DTMF and ETSI FSK. These protocols allow signaling while the terminal is in an “on-hook” state, i.e. before a call is being seized.

In order to support CLIP, all operators involved in a call must properly forward a Calling-Line Identifier (CLI). An operator that properly forwards CLI can expect a business advantage since customers are willing to pay extra for this service. Occasionally though, CLI-forwarding fails.

To be certain that the CLI forwarding works correctly, operators perform statistical tests. These tests can be performed in different ways. Typically, test calls are made, and statistics relating to CLI are collected and presented. A CLI forwarding success rate is a measure of the quality of the CLI forwarding in the network.

The operators also test voice quality by making test calls in the voice-oriented networks. A voice test-signal is for example played by the called party, and is recorded and analyzed by the calling party. A recorded voice test-signal is called a voice clip.

Perceptual Evaluation of Speech Quality (PESQ) and Non-Intrusive Quality Assessment (NIQA) are two commonly used methods for testing of voice quality in voice-oriented networks.

There exist quality measurement systems that automate testing of voice-oriented networks, e.g. “Test Call System” (TCS) by Arptel Ltd. TCS performs various tests, including NIQA, PESQ and CLI-forwarding.

In TCS, there are dialers strategically placed at different locations in the world from where test calls are to be initiated and received. A dialer is a device that expedites automated telephone calls under the control of a server. Dialers are capable of initiating and/or receiving telephone calls.

The dialers are connected to voice-oriented networks of the global telecommunications interconnection network by means of e.g. a Plain Ordinary Telephone Service (POTS) interface, an Integrated Services Digital Network Basic Rate Interface (ISDN-BRI), an E1/T1 having an Integrated Services Digital Network Primary Rate Interface (ISDN-PRI) or an E1/T1 having an SS7 interface.

A dialer that interfaces to the voice-oriented network through a POTS interface is called a POTS dialer, and a dialer that interfaces to the voice-oriented network through an ISDN-BRI interface is called an ISDN-BRI dialer. A dialer that interfaces to the voice-oriented network through an ISDN-PRI is called an ISDN-PRI dialer, and a dialer that interfaces to the voice-oriented network through an SS7 interface is called an SS7 dialer.

Voice connections of the voice-oriented networks in the path of a test call will be subjected to testing. Testing also relates directly or indirectly to the associated common-channel-signaling networks, e.g. when testing CLI-forwarding.

In TCS, there are originating dialers and terminating dialers. These represent calling parties and called parties, respectively. Hence, originating dialers initiate calls, and terminating dialers receive calls.

The originating dialers are connected to TCS servers through a respective TCP/IP connection, through which control signaling between the originating dialers and the TCS servers is carried out.

The TCS servers may be located at different sites, but an operator typically purchases a TCS server and places on a site where Operation-and-Maintenance (OAM) is carried out.

Through TCP/IP, a TCS server may signal directly to an originating dialer through an Ethernet connection, or the TCS server and the originating dialer may both be connected to the Internet, which facilitates a means for TCP/IP signaling. Internet access is provided e.g. by connecting to a LAN router.

For carrying out a voice-connection test in TCS, a voice test-signal is sent via the voice-oriented network from a terminating dialer to an originating dialer, where it is recorded. It is sent as a voice clip from the originating dialer to the TCS server via the TCP/IP connection. The voice clip is analyzed in the TCS server, and results are reported.

Signaling to and from terminating dialers is principally carried out inbound, i.e. through voice connections. The TCS servers command telephonic test-calls to be set up through the aid of the dialers. A TCS server commands, through TCP/IP, an originating dialer to initiate set-up of a test call to a terminating dialer. The originating dialer dials a number to the terminating dialer, and awaits a reply from the terminating dialer. In response, a voice connection is set up through the voice-oriented network, to the terminating dialer. Set up of a voice connection typically involves common-channel signaling through a data-oriented network, e.g. by means of Integrated Services digital Network User Part/Message Transfer Protocol (ISUP/MTP), but signals as to the type of tests to be carried out are sent inbound via the voice connection of the voice-oriented network.

The terminating dialer in turn attempts to decode CLI and seizes the call. If the test to be carried out is a CLI-forwarding test, the terminating dialer in turn encodes the CLI as Dual-Tone Multi-Frequency (DTMF), and sends it back to the originating dialer through the voice connection that has been set up by the voice-oriented network. The originating dialer receives the DTMF-encoded CLI, and decodes and forwards it to the TCS server through TCP/IP. The TCS server in turn checks it for correctness.

Test calls are repeatedly set up, and the results of several test calls are collected by the TCS server and reported as call statistics, e.g. as a printout of voice quality or CLI-forwarding success rate.

Some dialers handle multiple simultaneous calls, and are thus responsive to more than one telephone number, each representing a party.

Dialers are capable of routing control, i.e. routes for calls from the calling parties to the called parties are selectable by the dialer by using dialing prefixes. Thereby, problems with CLI may be localized to a specific network or operator by altering the routes.

In addition to owning a TCS server, an operator may also own dialers. Alternatively, several operators jointly own a number of dialers. Yet another alternative is that Arptel Ltd. or one of its partners provides access to its own dialers as a service. The latter two alternatives provide for pooling. Pooling is beneficial since the expense of multiple dialer sites in one and the same geographic area is avoided.

Another test system relating to CLI is described in U.S. Pat. No. 6,661,850. There is disclosed an exchange test system. A loop circuit is attached to the exchange, after a CLI transmitter. Firmware within the exchange analyzes a loop-back signal for normality.

US patent number RE40,634 discloses a parameter-monitoring system. A Calling Line Identifier allows analysis of call parameters from calls coming from one and the same agent in a call center.

A problem in the art is that assessment of voice quality in a TCS server is restricted to one direction because there is no appropriate network channel for sending voice clips from a terminating dialer to a TCS server. For example, the voice-clip would be degraded if sent through the voice connection from the terminating dialer to the originating dialer.

Another problem in the art relates to CLI-forwarding. DTMF signaling over a voice connection is dependent on the voice-connection quality, which is sometimes poor. CLI is not always detectable by the server, although it may correctly have been sent to a dialer.

Yet another problem is related to pooling. In order to efficiently utilize the dialers, they are preferably used by several operators. They are thus sharing the dialers in order to keep expenses down. The dialers are consequently controlled by several servers. As the number of servers increase, so does the number of busy-calls, since calls to a specific called party may have been initiated by several servers simultaneously. Busy-calls are a waste of dialer capacity.

There is another problem relating to cost. In order to send back information, test calls are seized, i.e. a dialer signals “off-hook” or something to that effect and sends CLI-information inbound over the voice connection, which incurs additional expenses in the form of call charges.

Yet another problem is that the dialers are susceptible to unauthorized usage. One operator may for example use other operators' dialers without consent. Unauthorized usage consumes capacity from a potentially scarce resource, among other things.

### SUMMARY OF THE INVENTION

The aforementioned problems and other problems are solved in a simple and unified way through the current invention. This is accomplished by a telecommunications quality measurement system comprising a Test-Call System (TCS) common server, a locking and queuing device in the TCS common server, and TCS servers and terminating dialers connected to the TCS common server through a data-oriented network.

The telecommunications quality measurement system in accordance with the invention comprises dialers that initiate and receive telephonic test-calls through voice-oriented networks under the control and supervision of TCS servers.

Exclusive right to command initiation of a test call to a party of a terminating dialer via an originating dialer is granted to the TCS servers, one at the time. Before a TCS server commands an originating dialer to initiate a test call to the party, the TCS common server is queried. The locking and queuing device of the TCS common server queues queries relating to the party from all TCS servers, and responds to them in a first-come-first-serve manner, thereby granting permission to command initiation of test calls to the party, to one TCS server after the other.

A lock relating to the party is set for the TCS server in the TCS common server, and is released by the TCS common server when the test-call is finished. At the release of the lock, the TCS common server serves a query that follows in the queue, as long as it is not empty.

Test results from the test calls are sent through a data-oriented network by means of TCP/IP, from the dialers to the TCS common server.

A system for measuring telecommunications quality in voice oriented networks comprises a first dialer and a second dialer being originating dialers, and a third dialer being a terminating dialer connected to voice-oriented networks. It further comprises a first test-call-system server and second test-call-system server connected to a respective one of said originating dialers by means of a data-oriented network.

Said system for measuring telecommunications quality is adapted for making test-calls and reporting test-call statistics and said originating dialers are adapted for initiating test-calls through voice-oriented networks under the control of said test-call-system servers.

A test-call-system common server is connected to said terminating dialer for control thereof, and connected to said first test-call-system server and second test-call-system server by means of said data-oriented network. Said first test-call-system server and second test-call-system server are each adapted for querying through a lock-query said test-call-system common server before commanding an originating dialer to initiate a test-call.

There is a locking and queuing device in said test-call-system common server, for setting and releasing locks, and for queuing lock-queries from said first test-call-system server and second test-call-system server in a way such that exclusive right to command initiation of test-calls to a party of the terminating dialer via an originating dialer is granted to the test-call-system servers one at the time.

Said terminating dialer is adapted for sending test data to said test-call-system common server through said data oriented network.

A method comprises steps as will now be explained. A lock query signal is sent from said first test-call-system server to a test-call-system common server. Moreover, a lock query signal is sent from said second test-call-system server to the test-call-system common server.

Upon receiving a lock query signal from the first test-call-system server, a party that relates to the terminating dialers is marked as busy in records of the test-call-system common server.

A lock reply signal is sent back to the first test-call-system server that sent the query, provided the party of said terminating dialer was free. On the other hand, a lock query signal from the second test-call-system server in the test-call-system common server is queued, provided a related party was busy.

When the party of the terminating dialer is free, a lock-reply signal is sent back to the second test-call-system server that sent the query that is next in line in the queue.

The party is marked as free when no query is queued, whereby exclusive right to command initiation of test-calls to a party of the terminating dialer via an originating dialer is granted to the test-call-system servers, one at the time.

Through the invention, authentication of TCS servers is enforced so that only authorized users gain access to test-call results from terminating dialers. Furthermore, busy-calls are avoided, voice-tests are improved, CLI-forwarding tests are carried out without seizing calls, and false answers are detected through false answer supervision.

### BRIEF DESCRIPTION OF DRAWINGS

The invention is illustrated in the accompanying drawings in which:

FIG. 1 is a schematic drawing of a telecommunications quality measurement system in accordance with the invention, connected to a voice-oriented network,

FIG. 2 is a schematic drawing of the telecommunications quality measurement system in accordance with the invention, in which TCP/IP connections in a data-oriented network have been emphasized,

FIG. 3 is a schematic drawing of the telecommunications quality measurement system in accordance with the invention, in which voice connections have been emphasized,

FIG. 4 is a flow chart of a locking and queuing method in accordance with the invention.

### DETAILED DESCRIPTION OF THE INVENTION

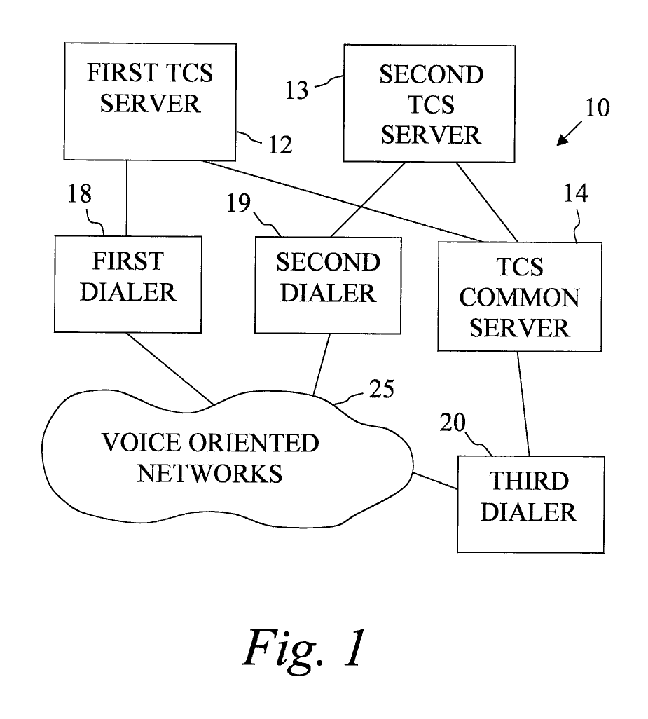

The invention will now be described in more detail. In FIG. 1 there is shown a telecommunications quality measurement system 10 in accordance with the invention. In the forthcoming, it will be called “Test-Call System” (TCS).

The TCS 10 comprises a first TCS server 12, a second TCS server 13, a TCS common server 14, a first dialer 18, a second dialer 19 and a third dialer 20. The first dialer 18 and the second dialer 19 are originating dialers, while the third dialer 20 is a terminating dialer.

They are interconnected for facilitating data communication through TCP/IP as shown. Accordingly, the first TCS server 12, the second TCS server 13 and the third dialer 20 are connected to the TCS common server 14 for facilitating data communication. Moreover, the first dialer 18 is connected to the first TCS server 12, and the second dialer 19 is connected to the second TCS server 13 for facilitating data communication.

The first dialer 18, the second dialer 19, and the third dialer 20 are furthermore connected to interconnected voice-oriented networks 25.

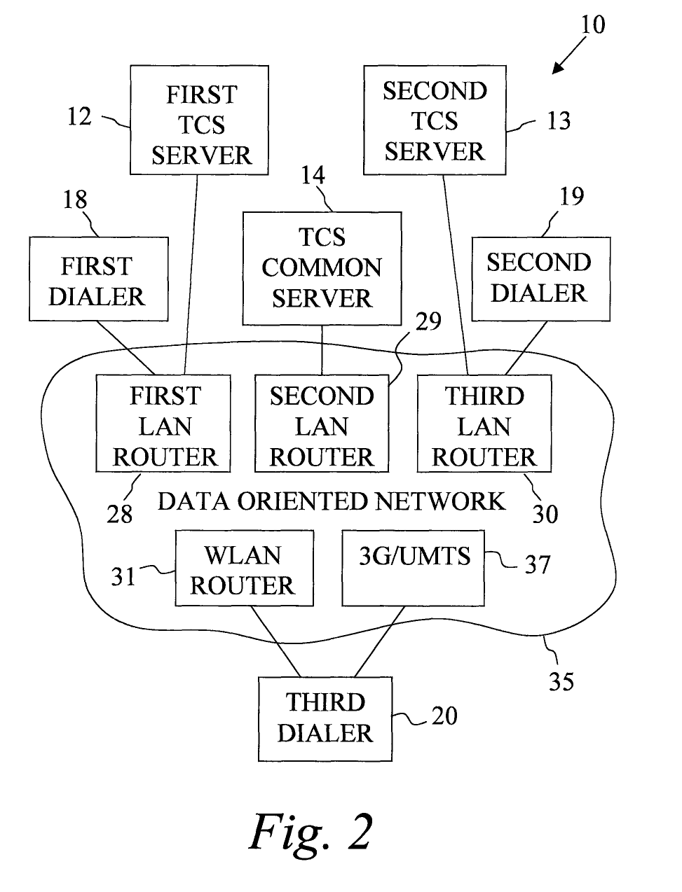

The means to interconnect the first TCS server 12, the second TCS server 13, the TCS common server 14, the first dialer 18, the second dialer 19 and the third dialer 20 for TCP/IP based data communication are e.g. through Ethernet, LANs, WLANs and 3G/UMTS. Referring to FIG. 2, the first dialer 18 and the first TCS server 12 are connected to a first LAN router 28, the TCS common server 14 is connected to a second LAN router 29, the second dialer 19 and the second TCS server 13 are connected to a third LAN router 30, and the third dialer 20 is connected to a WLAN 31. The first LAN router 28, the second LAN router 29 and the third LAN router 30 provide TCP/IP based data communication services through a data-oriented network 35.

Alternatively, the third dialer 20 is connected to a 3G/UMTS cellular network 37 that also provides TCP/IP based data communication services through the data-oriented network 35.

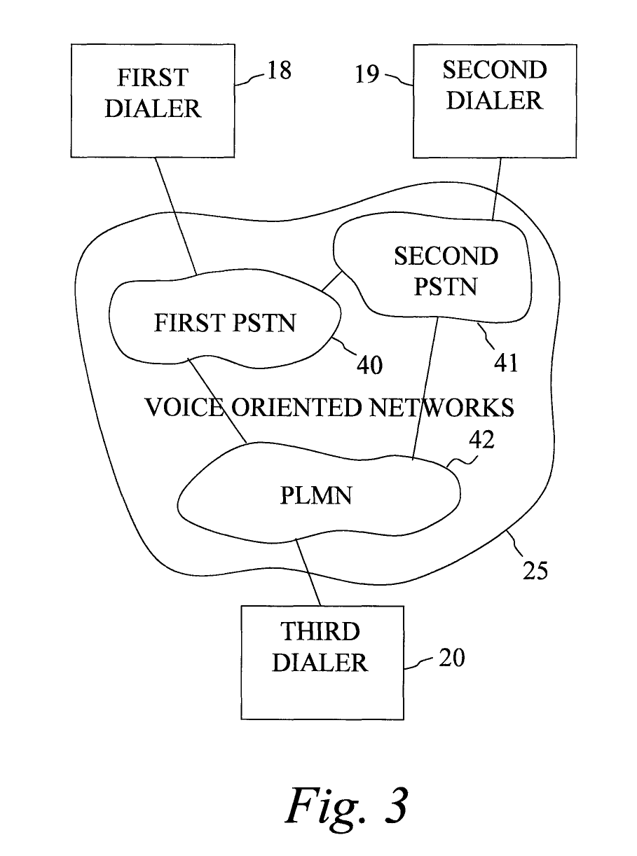

With reference to FIG. 3, the first dialer 18, the second dialer 19 and the third dialer 20 are connected to the voice-oriented networks 25 of the global telecommunications interconnection network.

In more detail, the first dialer 18 is an SS7 dialer. It has a 1.5 Mbit/s T1 PCM trunk line interface. Through this interface, the first dialer 18 is connected to a first PSTN 40.

The second dialer 19 is also an SS7 dialer. It has a 2 Mbit/s E1 PCM trunk line interface. Through this interface, the second dialer 19 is connected to a second PSTN 41.

The third dialer 20 is a Nokia E51 cellular telephone that interconnects with voice networks through a PLMN 42, in this case a GSM or 3G/UMTS network.

TCS tests voice-oriented networks with regard to CLI forwarding, voice connection quality and false answers among other things. Such tests are typically carried out by operators to assess and verify their own voice-oriented networks as well as their contractors' voice-oriented networks. In order to do so, they employ the first dialer 18, the second dialer 19 and the third dialer 20 that are located at various locations in the global telecommunications interconnection network.

In the embodiment shown, a first operator controls the first dialer 18 via the first TCS server 12. The first dialer 18 is an originating dialer. A second operator controls the second dialer 19 via the second TCS server 13. The second dialer 19 is also an originating dialer. The third dialer 20 is a terminating dialer. It is controlled via the TCS common server 14.

CLI and other test data received in a terminating dialer are sent to the TCS common server 14 through the data-oriented network 35, as opposed to inbound through a voice connection.

For controlling the first dialer 18, it is connected via the data-oriented network 35 that provides for TCP/IP signaling to the first TCS server 12. For controlling the second dialer 19, it is connected via the data-oriented network 35 to the second TCS server 13. For controlling the third dialer 20, it is connected via the data-oriented network 35 to the TCS common server 14. Thus, the originating dialers are connected to a respective TCS server for signaling. Terminating dialers on the other hand, in this case the third dialer 20, are connected to the TCS common server 14.

When the first operator wishes to perform a CLI forwarding test from the first dialer 18 to the third dialer 20, the first TCS server 12 is instructed to command such a test. Likewise, when the second operator wishes to perform a CLI forwarding test from the second dialer 19 to the third dialer 20, the second TCS server 13 is instructed to command such a test.

It is to be specifically noted that the third dialer 20 is a shared dialer. It is called a shared dialer because more than one TCS server use it for receiving test-calls.

The third dialer 20, i.e. the Nokia E51 cellular telephone is only capable of handling one call at the time. Accordingly, a potential conflict in time must be resolved so that the first TCS server 12 and the second TCS server 13 command their respective originating first dialer 18 and second dialer 19 to make test calls one after the other rather than concurrently.

A second TCS server 13 commanding a test call to be initiated while another test call is ongoing would yield a busy-call, which would be inefficient. A busy call results when an originating dialer calls a party of a terminating dialer that already has a voice connection set up to another party.

Therefore, upon receiving the instructions to command the initiation of a test-call for carrying out a CLI forwarding test, the first TCS server 12 and the second TCS server 13 send a respective query signal to the TCS common server 14, asking for permission to command initiation of a test call to the third dialer 20. It is called a lock query signal.

The TCS common server 14 keeps records of the lock query signals received from TCS servers, and a locking and queuing device is embodied in the TCS common server 14 that allows only one TCS server at the time to command initiation of a test call to a specific party of a shared dialer.

If the party is free, the TCS common server 14 marks it busy in its records, and sends a lock reply signal right away to the TCS server that sent the lock query signal. The busy mark is called a lock. If on the other hand the party is busy, then the lock query is queued in a first-come-first-serve manner, and a lock reply signal is sent in due course after TCS servers that sent lock queries earlier in time have been served.

When the first TCS server 12 receives its lock reply signal, it commands initiation of a test-call by sending a call request signal to the first dialer 18. The first dialer 18 calls up the third dialer 20 through the voice networks 25. The third dialer 20 decodes CLI and sends it through a TCP/IP connection to the TCS common server 14. The TCS common server 14 in turn sends it, via TCP/IP, to the first TCS server 12. When the test-call finishes, the lock is released, i.e. the party is marked free in the records of the TCS common server 14. If there are further lock queries pending, the TCS common server 14 sets a new lock and sends a lock reply signal to a server next in line.

In this example, the next server in line is the second TCS server 13. The second TCS server 13 then receives its lock reply signal and sends a call request signal to the second dialer 19. The second dialer 19 calls up the third dialer 20 through the voice networks 25. The third dialer 20 decodes CLI and sends it through a TCP/IP connection to the TCS common server 14. The TCS common server 14 in turn sends it, via TCP/IP, to the second TCS server 13.

When the test instructed by the operator is a CLI-forwarding test, there is no need for the terminating dialer to seize the call. It simply sends the decoded CLI to the TCS common server 14 via TCP/IP. The TCS common server 14 knows the destination of the CLI because it knows to which TCS server the lock request is granted at any given time.

The first TCS server 12 checks the CLI for correctness, and reports its results to the first operator. Likewise, the second TCS server 13 checks the CLI for correctness, and reports its results to the second operator.

The TCS 10 may also be instructed to carry out the aforementioned other tests. This is done in a similar fashion, although the terminating dialers actually seize the calls. Information as to the type of test to be carried out is communicated to the third dialer 20 via the TCS common server 14.

False-answer supervision is one of the tests that TCS 10 carries out. It does so by sending the time of call seizure from the terminating dialer 20 to the appropriate first TCS server 12 or second TCS server 13. If a connect message or the like is sent prior to the seizure of the call, a false answer is reported.

WLAN is generally the preferred choice for TCP/IP communication for the third dialer 20, but in case of lack of radio coverage or failure of WLAN, the third dialer 20 uses 3G/UMTS, through General Packet Radio Service (GPRS), for connecting to TCP/IP as a fail-over. The dialer is set up for automatically switching to 3G/UMTS in the absence of a WLAN connection.

Data communication between the TCS common server 14 and a terminating dialer 20 is initiated by the terminating dialer 20 when being called up. Alternatively, data communication between the TCS common server 14 and a terminating dialer 20 is initiated by the TCS common server 14. In the latter case, when the TCS common server 14 for example sends a lock-reply signal to the controlling TCS server 12,13, the TCS common server 14 also sets up a TCP/IP data connection between the TCS common server 14 and the terminating dialer 20.

Typically, an operator originates test calls from its own network, while termination takes place in other networks. However, a terminating dialer may also become an originating dialer, and the operator may originate test calls from a dialer in a remote network.

Password authentication is used in the TCS common server 14. Thereby, an operator cannot get meaningful results from dialers without authorization. In the TCS common server 14, there is an authentication device that allows access only if a correct password is given. The authentication device has lists of passwords and dialers and/or parties relating to each TCS server.

The Nokia E51 cellular telephone has a Symbian Operating System (OS). The dialer function of the third dialer 20 is an application on the Symbian OS. The application interfaces with the voice-oriented networks and the data-oriented networks through Application Program Interfaces (APIs). The Nokia E51 cellular telephone connects to an Internet Web site from where the dialer application is downloaded. The Nokia E51 is just an example of a device suitable for embodying a dialer in accordance with the invention.

For clarity and conciseness, there are only two originating dialers and one terminating dialer shown and described in the embodiments, each of which dialer has only one party. This is not to be construed as a limitation of the invention. As a matter of fact, the TCS 10 may have tens of dialers, and hundreds of parties. In a TCS 10 with a large number of dialers, there are potentially hundreds of lock queries in the TCS common server 14.

In the TCS 10, there is also an arbitrary mix of types of dialers without departing from the scope and the spirit of the invention. Furthermore, the TCS common server 14 may be duplicated for redundancy. The necessary alterations for alternative embodiments in accordance with the aforesaid would be obvious to someone skilled in the art.

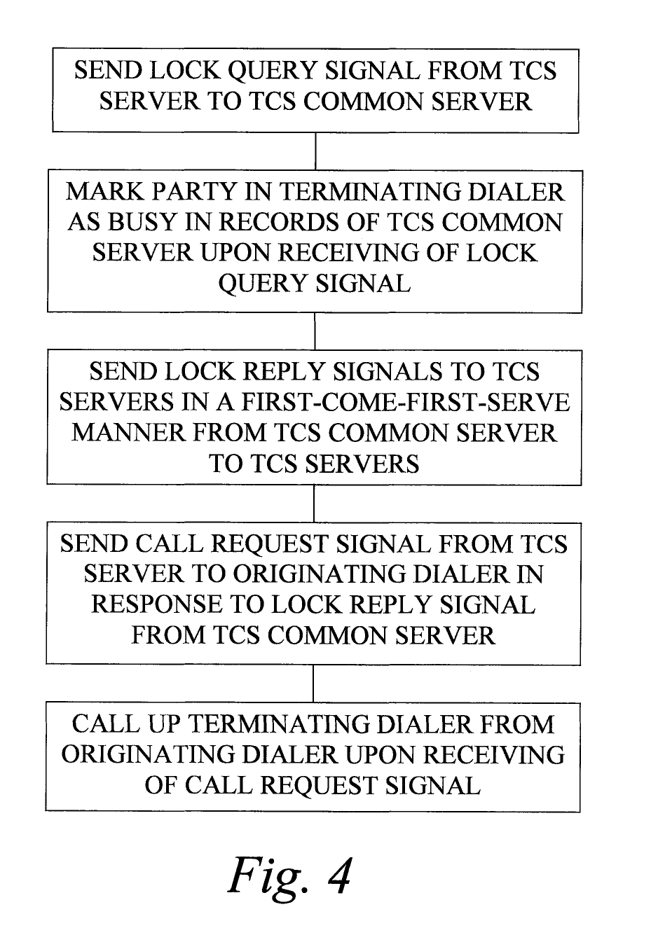

The method in accordance with the invention will now be described with reference to FIG. 4.

A lock query signal is sent from a TCS server 12,13 to the TCS common server 14, see the first box. When the lock query signal is received in the TCS common server 14, a party in a terminating dialer 20 is marked as busy in records of the TCS common server 14, see the second box.

Lock reply signals are sent to TCS servers 12,13 in a first come first serve manner from the TCS common server 14, see the third box. In response to a lock reply signal from the TCS common server 14, a TCS server 12,13 sends a call request signal to an originating dialer 18,19, see the fourth box.

When receiving the call request signal, the originating dialer 18,19 calls up the terminating dialer 20, see the fifth box.

1. A system for measuring telecommunications quality in voice oriented networks comprising a first dialer and a second dialer being originating dialers, and a third dialer being a terminating dialer connected to voice-oriented networks, and a first test-call-system server and second test-call-system server connected to a respective one of said originating dialers by means of a data-oriented network, where said system for measuring telecommunications quality is adapted for making test-calls and reporting test-call statistics and said originating dialers are adapted for initiating test-calls through voice-oriented networks under the control of said test-call-system servers, comprising:
a test-call-system common server connected to said terminating dialer for control thereof, and connected to said first test-call-system server and second test-call-system server by means of said data-oriented network, where said first test-call-system server and second test-call-system server each is adapted for querying through a lock-query said test-call-system common server before commanding an originating dialer to initiate a test-call and
a locking and queuing device in said test-call-system common server, for setting and releasing locks, and for queuing lock-queries from said first test-call-system server and second test-call-system server in a way such that exclusive right to command initiation of test-calls to a party of the terminating dialer via an originating dialer is granted to the test-call-system servers one at the time, where said terminating dialer is adapted for sending test data to said test-call-system common server through said data oriented network.

2. A telecommunications quality measurement system in accordance with claim 1, further comprising:
an authentication device having lists of passwords and dialers and/or parties relating to each test-call-system server.

3. A telecommunications quality measurement system in accordance with claim 2, wherein:
said terminating dialer is a cellular telephone.

4. A telecommunications quality measurement system in accordance with claim 3, wherein further:
said terminating dialer connects to said data-oriented network via WLAN and in the absence of WLAN coverage connects to said data-oriented network via 3G/UMTS.

5. A method in a system for measuring telecommunications quality in voice-oriented networks, where said system comprises a first dialer and a second dialer being originating dialers, and a third dialer being a terminating dialer connected to voice-oriented networks, and a first test-call-system server and second test-call-system server connected to a respective one of said originating dialers by means of a data-oriented network, where said originating dialers initiate test-calls through voice-oriented networks under the control of said test-call-system servers, comprising:
sending a lock query signal from said first test-call-system server to a test-call-system common server,
sending a lock query signal from said second test-call-system server to the test-call-system common server,
upon receiving a lock query signal from the first test-call-system server, marking a party that relates to the terminating dialers as busy in records of the test-call-system common server and send back a lock reply signal to the first test-call-system server that sent the query, provided the party of said terminating dialer was free,
queuing the lock query signal from the second test-call-system server in the test-call-system common server, provided a related party was busy,
when the party of the terminating dialer is free, sending a lock-reply signal back to the second test-call-system server that sent the query that is next in line in the queue, and
marking the party as free when no query is queued,
whereby exclusive right to command initiation of test-calls to a party of the terminating dialer via an originating dialer is granted to the test-call-system servers, one at the time.

6. A method in a telecommunications quality measurement system in accordance with claim 5, comprising:
awaiting said lock-reply signal in the first test-call-system server, and when it is received sending a call request signal to the first dialer,
awaiting said lock-reply signal in the second test-call-system server, and when it is received sending a call request signal to the second dialer.

7. A method in a telecommunications quality measurement system in accordance with claim 6, comprising:
using password authentication to allow test-call-system servers to only use dialers that they are authorized to use.

8. A method in a telecommunications quality measurement system in accordance with claim 7, comprising:
supervising false answers.
